(19) United States
(12) Patent Application Publication
(10) Pub. No.: US 2019/0143926 A1
(43) Pub. Date: May 16, 2019

(54) VEHICLE MANAGEMENT SYSTEM, INSPECTION INFORMATION TRANSMISSION SYSTEM, INFORMATION MANAGEMENT SYSTEM, VEHICLE MANAGEMENT PROGRAM, INSPECTION INFORMATION TRANSMISSION PROGRAM, AND INFORMATION MANAGEMENT PROGRAM

(71) Applicant: AISIN AW CO., LTD., Anjo-shi (JP)

(72) Inventors: Yoichi YAMAMURA, Okazaki-shi (JP); Yuichi KURIWAKI, Okazaki-shi (JP); Hirokazu HIRAI, Okazaki-shi (JP)

(73) Assignee: AISIN AW CO., LTD., Anjo-shi (JP)

(21) Appl. No.: 16/174,853

(22) Filed: Oct. 30, 2018

(30) Foreign Application Priority Data
Nov. 15, 2017 (JP) 2017-219585

(51) Int. Cl. B60R 21/0136; G07C 5/00; G06T 7/00

(52) U.S. Cl. CPC B60R 21/0136; B60R 2021/0027; G06T 7/001; G07C 5/008

(57) ABSTRACT

Vehicle management systems, methods and programs receive contact information indicating contact between an object and a vehicle. The contact information is detected by a sensor that detects contact between the object and the vehicle. The systems, methods, and programs obtain inspection information. The inspection information is a result of inspecting the vehicle for damage by a user of the vehicle who is notified of the contact between the object and the vehicle from having received the contact information. Inspection information transmission systems, methods, and programs, and information management systems, methods, and programs are also provided.

### INCORPORATION BY REFERENCE

The disclosure of Japanese Patent Application No. 2017-219585, filed on Nov. 15, 2017, including the specification, drawings and abstract is incorporated herein by reference in its entirety.

### BACKGROUND

Related technical fields include vehicle management systems, inspection information transmission systems, information management systems, vehicle management programs, inspection information transmission programs, and information management programs.

In car sharing services and car rental services, it is necessary to check if any damage occurred to the vehicle while the user was using it. For example, Japanese Patent Application Publication No. 2011-95880 (JP 2011-95880 A) is known as a technique that assists in checking for damage to a vehicle. JP 2011-95880 A discloses a technique of checking the vehicle's condition before and after use, and if abnormality that occurred during use is detected after use, transmitting abnormality information from an in-vehicle device to an automobile management device.

### SUMMARY

In the related art, whether abnormality occurred during use or not is detected by comparing the vehicle's conditions before renting and after returning the vehicle. Accordingly, whether the vehicle has been damaged or not will not be known until it is returned. Car sharing service providers or car rental service providers may not be able to lend a vehicle if it has damage. In that case, they need to prepare a substitute vehicle etc. before the next reservation.

Exemplary embodiments of the broad inventive principles described herein address the above problem and have an object to provide a technique of raising the possibility of early recognition of vehicle damage.

Exemplary embodiments provide vehicle management systems, methods, and programs that receive contact information indicating contact between an object and a vehicle. The contact information is detected by a sensor that detects contact between the object and the vehicle. The systems, methods and programs obtain inspection information. The inspection information is a result of inspecting the vehicle for damage by a user of the vehicle who is notified of the contact between the object and the vehicle from having received the contact information.

An administrator who uses the vehicle management systems, methods, and programs can recognize from the contact information that contact between the object and the vehicle has been detected. The user is also notified of the contact between the object and the vehicle. The user notified of the contact inspects the vehicle for damage. The inspection information indicating the inspection result is transmitted to the vehicle management system. The administrator who uses the vehicle management systems, methods, and programs can therefore recognize the user's own inspection result.

Further, in a situation where damage to the vehicle is suspected, the user's own damage inspection result can be obtained. The user's own damage inspection result is provided also to the administrator. This raises the possibility that the administrator can recognize damage to the vehicle early before the vehicle is returned.

Exemplary embodiments provide inspection information transmission systems, methods, and programs that obtain position information indicating a detected contact position of a vehicle with an object, and notify a user of the obtained position information. The systems, methods, and programs obtain image information indicating an image of the detected contact position. The obtained image information is captured by a camera. The systems, methods, and programs obtain damage information indicating whether there is damage to the vehicle at the detected contact position, and transmit inspection information containing the obtained image information and the obtained damage information.

The user of the vehicle uses the inspection information transmission system. When contact between the object and the vehicle is detected, the inspection information transmission system is notified of the position information indicating the contact position. In this case, the user captures an image including the contact position with a camera to check if there is damage to the vehicle. The image information indicating the captured image and the damage information indicating whether there is damage to the vehicle or not are transmitted to the vehicle management system. Accordingly, if the user checks if there is damage to the vehicle, the administrator can also recognize whether there is damage to the vehicle or not. This raises the possibility that the administrator can recognize damage to the vehicle early before the vehicle is returned.

Exemplary embodiments provide information management systems, methods, and programs that obtain contact information indicating contact between an object and a vehicle. The contact information is detected by a sensor that detects contact between the object and the vehicle. The systems, methods, and programs transmit the obtained contact information to a vehicle management system that is used by an administrator of the vehicle and an inspection information transmission system that is used by a user of the vehicle, and obtain inspection information. The inspection information is a result of inspecting the vehicle for damage by the user by using the inspection information transmission system. The systems, methods, and programs transmit the inspection information to the vehicle management system.

The information management systems, methods, and programs manage the contact information generated when contact between the object and the vehicle is detected and the inspection information, which is the result of inspecting the vehicle for damage by the user, and provides the contact information and the inspection information to the vehicle management system. The administrator can thus recognize from the contact information that damage may have occurred to the vehicle. This raises the possibility that the administrator can recognize damage to the vehicle early.

### BRIEF DESCRIPTION OF THE DRAWINGS

FIG. 1A shows a system that operates with a vehicle management system and FIG. 1B is a block diagram showing the configuration of a navigation system;

FIG. 2A is a block diagram showing the configuration of an information management system and FIG. 2B is a block diagram showing the configuration of the vehicle management system;

FIG. 3 is a block diagram showing the configuration of an inspection information transmission system;

FIG. 4 is a flowchart of a contact information transmission process;

FIG. 5A is a flowchart of an information management process 1 and FIG. 5B is a flowchart of an information management process 2; and

FIG. 6A is a flowchart of an inspection information transmission process and FIG. 6B is a flowchart of a vehicle management process.

### DETAILED DESCRIPTION OF EXEMPLARY EMBODIMENTS

Exemplary embodiments will be described below in the following order.
(1) How Service is Implemented
(2) Configuration of Navigation System
(3) Configuration of Information Management System
(4) Configuration of Vehicle Management System
(5) Configuration of Inspection Information Transmission System
(6) Contact Information Transmission Process
(7) Information Management Process
(8) Inspection Information Transmission Process
(9) Vehicle Management Process
(10) Other Embodiments

### (1) How Service is Implemented

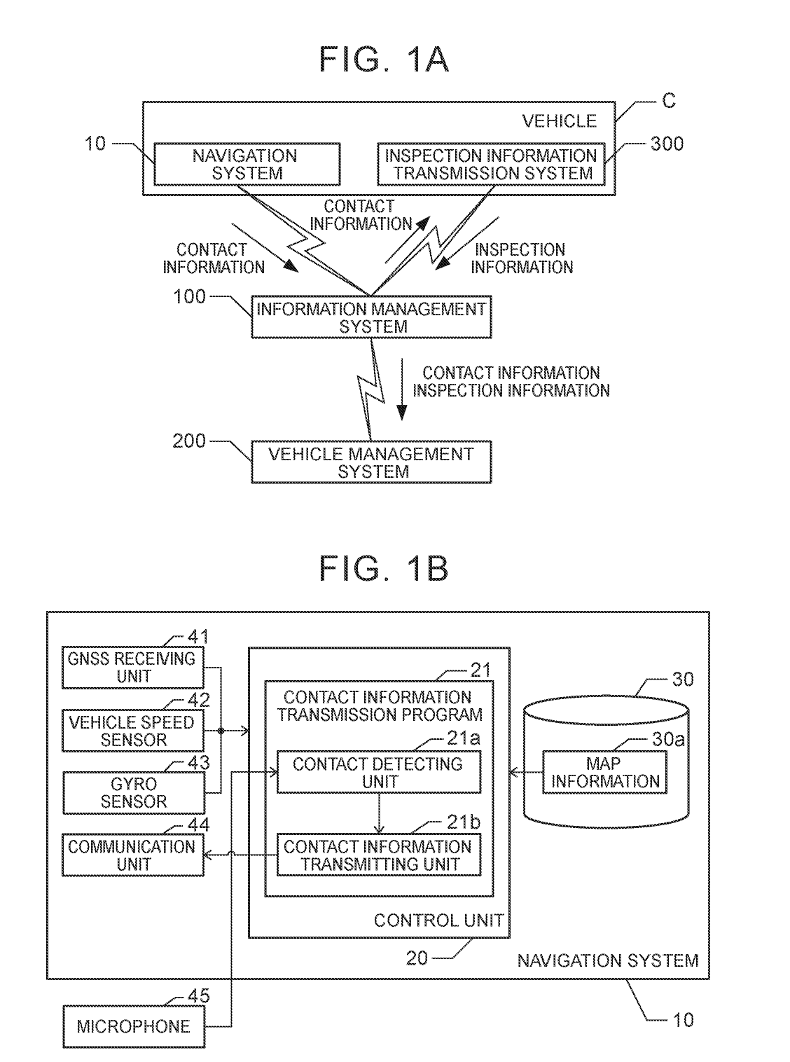

FIG. 1A shows an example of the configuration of a system that operates with a vehicle management system 200. FIGS. 1A and 1B show an embodiment in which an administrator of vehicles C who provides a car sharing service installs the vehicle management system 200 at one or more locations and provides a service for sharing a plurality of vehicles C by using an information management system 100. In the present embodiment, the vehicles C for the car sharing service use a navigation system 10. The user of the car sharing service has a mobile terminal such as a smartphone. The mobile terminal functions as an inspection information transmission system 300.

The information management system 100 can wirelessly communicate with the navigation system 10, the inspection information transmission system 300, and the vehicle management system 200. The navigation system 10 can detect with a sensor contact between an object and the vehicle C. The navigation system 10 transmits contact information indicating an estimated contact position with the object etc. to the information management system 100. The information management system 100 stores the contact information received from the navigation system 10 in a recording medium.

The information management system 100 transmits the contact information to the vehicle management system 200 and the inspection information transmission system 300. When the vehicle management system 200 receives the contact information, the administrator who uses the vehicle management system 200 recognizes that the vehicle C may have been damaged by contact with an object.

When the inspection information transmission system 300 receives the contact information, the user of the vehicle C (the user of the car sharing service) who uses the inspection information transmission system 300 recognizes that the vehicle C may have been damaged by contact with an object. In this case, the user of the vehicle C himself/herself inspects the vehicle C for damage and transmits inspection information indicating the inspection result to the information management system 100.

When the information management system 100 receives the inspection information, it stores the received inspection information in the recording medium and also transmits the received inspection information to the vehicle management system 200. When the vehicle management system 200 receives the inspection information, the administrator who uses the vehicle management system 200 recognizes the user's own inspection result of whether the vehicle C has been damaged or not.

As described above, in the present embodiment, the administrator who uses the vehicle management system 200 can receive a notification of possible damage to the vehicle C (first notification) by receiving the contact information. In this case, the administrator can also receive the user's own inspection result of whether the vehicle C has been damaged or not (second notification). If the inspection information transmission system 300 receives the contact information, the user takes action such as parking the vehicle C to transmit the inspection information. This allows the administrator to recognize whether the vehicle C has been damaged or not before the user returns the vehicle C and thus raises the possibility of early recognition of vehicle damage. Since the administrator can recognize damage to the vehicle C before the user returns the vehicle C, the administrator can make preparations such as preparing for a substitute vehicle before the next reservation.

The sensor included in the navigation system 10 may falsely detect contact between an object and the vehicle C. In the present embodiment, however, the user himself/herself inspects the vehicle C for damage and transmits the inspection result. Accordingly, in the case where the user recognizes damage to the vehicle C, he/she can share the fact that damage has occurred to the vehicle C with the administrator before the administrator inspects the vehicle C for damage. This reduces administrator's time and effort for damage inspection. In the case where it is obvious from the inspection information that no damage has occurred to the vehicle C, the administrator need not inspect the vehicle C for damage. This also reduces administrator's time and effort for damage inspection. The administrator inspects the vehicle C for damage in situations where damage to the vehicle C is suspected, such as in the case where it is obvious from the inspection information that damage has occurred to the vehicle C but the user does not admit it or in the case where the user has refused to inspect the vehicle C for damage. This reduces administrator's time and effort for damage inspection as compared to the case where the administrator inspects all of the vehicles C for damage.

### (2) Configuration of Navigation System

The configuration of the navigation system 10 will be described in detail. FIG. 1B is a block diagram showing the configuration of the navigation system 10. The vehicle C for the car sharing service is equipped with the navigation system 10 according to the present embodiment. There may be a plurality of similar vehicles C (vehicles equipped with the navigation system 10).

The navigation system 10 is a terminal that gives guidance to the user so that the user can drive the vehicle C along a planned travel route. In the present embodiment, the navigation system 10 has a function to specify the situation where damage is presumed to have occurred to the vehicle C. The navigation system 10 includes a control unit 20 including a CPU, a RAM, a ROM, etc., a recording medium 30, a GNSS receiving unit 41, a vehicle speed sensor 42, a gyro sensor 43, and a communication unit 44. The control unit 20 can execute a navigation program, not shown, stored in the recording medium 30 or the ROM. (As used herein, the term “recording medium” does not encompass transitory signals.)

Map information 30a is recorded in advance on the recording medium 30. The map information 30a is information that is used to specify the position of the vehicle C and a destination facility. The map information 30a contains node data indicating the positions etc. of nodes set on roads on which the vehicle C travels, shape interpolation point data indicating the positions etc. of shape interpolation points for specifying the shape of a road between nodes, link data indicating connections between nodes, data indicating the positions etc. of roads and features that are present around the roads, etc.

The GNSS receiving unit 41 is a device that receives signals of a global navigation satellite system (GNSS). The GNSS receiving unit 41 receives radio waves from a navigation satellite and outputs a signal for calculating the current position of the vehicle C via an interface, not shown. The control unit 20 receives this signal and obtains the current position of the vehicle C. The vehicle speed sensor 42 outputs a signal corresponding to the rotational speed of wheels of the vehicle C. The control unit 20 receives this signal via the interface, not shown, and obtains the vehicle speed. The gyro sensor 43 detects angular acceleration of the vehicle C turning in a horizontal plane and outputs a signal corresponding to the direction of the vehicle C. The control unit 20 receives this signal and obtains the direction in which the vehicle C is traveling. The vehicle speed sensor 42, the gyro sensor 43 etc. are used to specify the path along which the vehicle C has traveled. In the present embodiment, the current position is specified based on the departure point of the vehicle C and the path along which the vehicle C has traveled, and the current position of the vehicle C specified based on the departure point and the path along which the vehicle C has traveled is corrected based on the output signal of the GNSS receiving unit 41.

The communication unit 44 includes a circuit that communicates with other devices. By executing the navigation program, the control unit 20 can communicate with the information management system 100. The vehicle C equipped with the navigation system 10 includes a microphone 45. The microphone 45 is a device that detects sound and outputs a signal indicating the detected sound, and the vehicle C is equipped with a plurality of microphones 45 at a plurality of locations. The microphones 45 are connected to the navigation system 10 via the interface, not shown, and the control unit 20 can obtain signals output from the microphones 45.

Since the vehicle C is equipped with the plurality of microphones 45, the control unit 20 obtains output signals of the microphones 45 associated with the positions of the microphones 45. In the present embodiment, the microphones 45 are used to detect sound that is made when an object contacts the body of the vehicle C. That is, the present embodiment is configured to detect contact between an object and the body of the vehicle C by sound that is made when the object contacts the body of the vehicle C.

By the functions of the navigation program, not shown, the control unit 20 can receive destination input from the driver via an input unit of a user interface (I/F) unit, not shown, and search a planned travel route from the current position of the vehicle C to the destination based on the map information 30a. By the functions of the navigation program, the control unit 20 can also provide the driver of the vehicle C with route guidance on the planned travel route via an output unit of the user I/F unit, not shown, based on the map information 30a.

The navigation program according to the present embodiment allows the control unit 20 to perform a function to detect contact between an object and the vehicle C. The navigation program includes a contact information transmission program 21 in order to realize such contact detection. The contact information transmission program 21 includes a contact detecting unit 21a and a contact information transmitting unit 21b.

The contact detecting unit 21a is a program module that allows the control unit 20 to perform a function to detect contact between an object and the vehicle C. That is, the control unit 20 obtains output signals of the microphones 45 and records them on a memory such as the RAM. The control unit 20 determines if any of the recorded output signals is a signal indicating contact of an object. If so, the control unit 20 extracts output signals that were output during a predetermined period before and after that signal (e.g., for several seconds).

Various methods may be used to specify if an output signal is a signal that indicates contact of an object. Various configurations can be used such as a configuration in which it is specified whether or not the signal amplitude is equal to or larger than a threshold or a configuration in which it is specified whether or not the signal frequency is a frequency that is characteristic of contact of an object. In the case where an output signal of any of the microphones 45 is a signal indicating contact of an object, the control unit 20 generates contact information by associating position information indicating the position of that microphone 45 with the signals output from that microphone 45 during the predetermined period.

The control unit 20 adds other information to the contact information. In the present embodiment, the control unit 20 associates identification information of the vehicle C (the vehicle number etc.), the point where contact occurred (the current positon of the vehicle C upon detection of contact etc.), and the time contact occurred with the contact information. The contact information transmitting unit 21b allows the control unit 20 to perform a function to transmit the contact information to an external system. In the present embodiment, the navigation system 10 transmits the contact information to the information management system 100. The control unit 20 therefore transmits the contact information to the information management system 100 via the communication unit 44.

### (3) Configuration of Information Management System

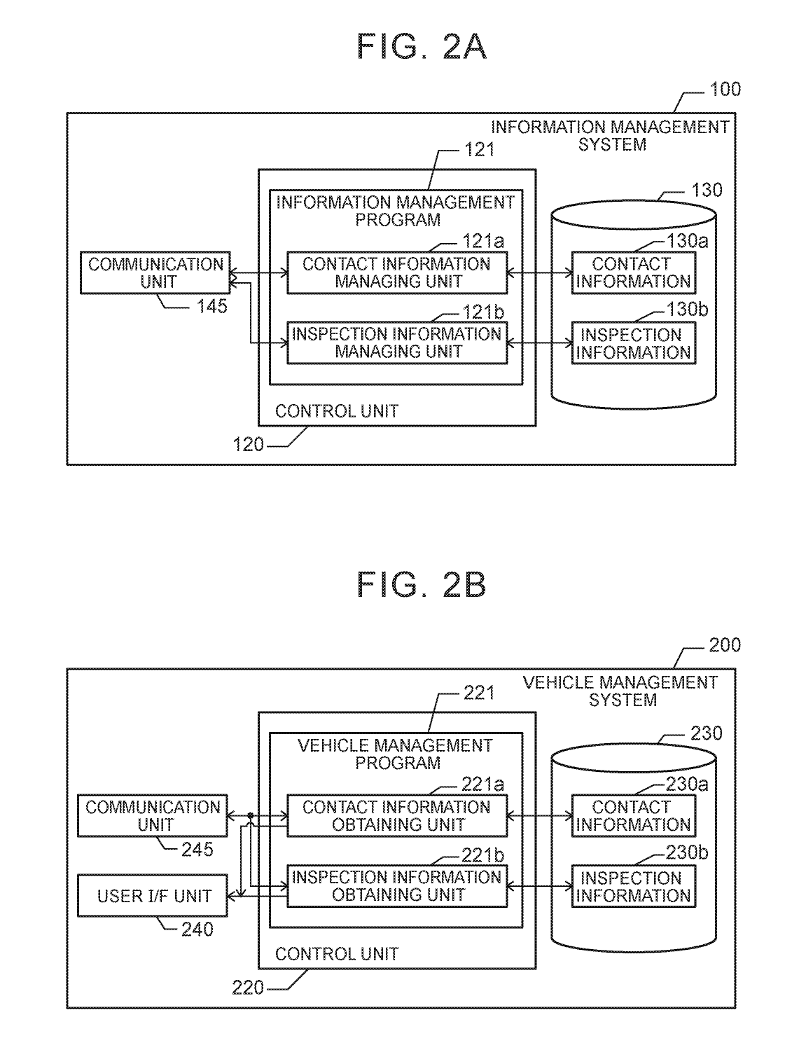

The configuration of the information management system 100 will be described in detail. FIG. 2A is a block diagram showing the configuration of the information management system 100. The information management system 100 according to the present embodiment has a function to manage information for sharing information about whether damage has occurred to the vehicle C or not between the user of the vehicle C and the administrator, in the case where the vehicle C may have been damaged. In the present embodiment, the information management system 100 is a server that can communicate with the navigation system 10, the vehicle management system 200, and the inspection information transmission system 300. The server that forms the information management system 100 may be formed by a single server or may be a server formed by a plurality of servers (e.g., a crowd server).

The information management system 100 includes a control unit 120 including a CPU, a RAM, a ROM, etc., a recording medium 130, and a communication unit 145. The control unit 120 can execute an information management program 121 stored in the recording medium 130 or the ROM.

The information (contact information 130a) transmitted from the navigation system 10 and the information (inspection information 130b) transmitted by the inspection information transmission system 300 can be recorded on the recording medium 130. The communication unit 145 includes a circuit that communicates with other devices. By executing the information management program 121, the control unit 120 can communicate with the navigation system 10, the vehicle management system 200, and the inspection information transmission system 300. In the present embodiment, the information management system 100 collects information from the systems that are used in the vehicle C, i.e., the navigation system 10 and the inspection information transmission system 300, and provides the vehicle management system 200 with the information.

In order to perform this process, the information management program 121 includes a contact information managing unit 121a and an inspection information managing unit 121b. The contact information managing unit 121a is a program module that allows the control unit 120 to perform a function to obtain contact information indicating contact of an object detected by the sensor for detecting contact between an object and the vehicle C and transmit the contact information to the vehicle management system 200 that is used by the administrator of the vehicle C and the inspection information transmission system 300 that is used by the user. That is, the control unit 120 receives the contact information 130a from the navigation system 10 via the communication unit 145 and records the contact information 130a on the recording medium 130.

After receiving the contact information 130a, the control unit 120 transmits the contact information 130a to the vehicle management system 200 and the inspection information transmission system 300 via the communication unit 145. The information management system 100 stores therein pieces of contact information 130a which are generated in response to detection of contact in the plurality of vehicles C, so that the information management system 100 can specify the contact information 130a for which damage was confirmed from inspection information that will be described below. The information management system 100 may be configured to extract from the collected pieces of contact information 130a the contact information 130a that suggests a strong possibility of damage to the vehicle C and transmit the extracted contact information 130a to the vehicle management system 200 and the inspection information transmission system 300.

The inspection information managing unit 121b is a program module that allows the control unit 120 to perform a function to obtain inspection information, namely the result of inspecting whether the vehicle C has been damaged or not by the user by using the inspection information transmission system 300, and transmit the inspection information to the vehicle management system 200. That is, the control unit 120 receives inspection information 130b from the inspection information transmission system 300 via the communication unit 145 and records the inspection information 130b on the recording medium 130.

After receiving the inspection information 130b, the control unit 120 transmits the inspection information 130b to the vehicle management system 200 via the communication unit 145. The inspection information 130b contains information indicating the user's own inspection result of whether there is damage to the vehicle C or not (damage information). The control unit 120 records on the recording medium 130 information that associates the contact information 130a transmitted to the inspection information transmission system 300 with the inspection information 130b received in response from the inspection information transmission system 300.

### (4) Configuration of Vehicle Management System

The configuration of the vehicle management system 200 will be described in detail. FIG. 2B is a block diagram showing the configuration of the vehicle management system 200. The vehicle management system 200 according to the present embodiment has a function to notify the administrator who manages the vehicle C that damage is presumed to have occurred to the vehicle C and also notify the administrator of the user's own inspection result of whether there is damage to the vehicle C or not.

In the present embodiment, the vehicle management system 200 can communicate with the information management system 100. The vehicle management system 200 includes a control unit 220 including a CPU, a RAM, a ROM, etc., a recording medium 230, a user I/F unit 240, and a communication unit 245. The control unit 220 can execute a vehicle management program 221 stored in the recording medium 230 or the ROM.

The recording medium 230 can record the information (contact information 230a, inspection information 230b) transmitted from the information management system 100 on the recording medium 230. The communication unit 245 has a circuit that communicates with the information management system 100. The user I/F unit 240 includes an input unit that receives input from the administrator and an output unit that displays information. The user I/F unit 240 can display desired information on the output unit. The way in which the output unit outputs information is not limited to displaying. Voice output etc. may be used instead of displaying.

By executing the vehicle management program 221, the control unit 220 can communicate with the information management system 100. In the present embodiment, the vehicle management system 200 provides the administrator of the vehicle C who uses the vehicle management system 200 with information.

In order to perform this process, the vehicle management program 221 includes a contact information obtaining unit 221a and an inspection information obtaining unit 221b. The contact information obtaining unit 221a is a program module that allows the control unit 220 to perform a function to obtain contact information indicating contact of an object detected by the sensor for detecting contact between an object and the vehicle C (in the present embodiment, the microphones 45). That is, the control unit 220 receives via the communication unit 245 the contact information 130a transmitted from the information management system 100 and records the contact information 130a on the recording medium 230 as contact information 230a.

The control unit 220 displays information about the contact information 230a on the output unit of the user I/F unit 240 by the function of the contact information obtaining unit 221a. In the present embodiment, the control unit 220 displays on the output unit of the user I/F unit 240 identification information of the vehicle C indicated by the contact information 230a and the position where damage is presumed to have occurred by contact with an object. That is, the control unit 220 refers to the contact information 230a and displays on the display unit of the user I/F unit 240 position information indicating the position of the microphone 45 associated with the contact information 230a. The administrator can thus recognize the vehicle C that is presumed to have been damaged and an estimated position of damage.

The inspection information obtaining unit 221b is a program module that allows the control unit 220 to perform a function to obtain inspection information, that is, the result of inspecting the vehicle C for damage by the user of the vehicle C who is notified that an object contacted the vehicle C. Namely, in the present embodiment, the user of the vehicle C is notified via the inspection information transmission system 300 that contact between an object and the vehicle C has been detected (which will be described in detail later). In this case, the user captures an image of a suspected position of damage with the inspection information transmission system 300, sets damage information on whether there is damage to the vehicle C or not, and transmits the damage information as inspection information. The information management system 100 receives and records the inspection information (inspection information 130b) thereon and transmits the inspection information to the vehicle management system 200.

The control unit 220 receives the inspection information 130b from the information management system 100 via the communication unit 245 and records the inspection information 130b on the recording medium 230 as inspection information 230b. The control unit 220 displays information regarding the inspection information 230b on the output unit of the user I/F unit 240 by the function of the inspection information obtaining unit 221b. In the present embodiment, the control unit 220 displays the image contained in the inspection information 230b and the information set by the user, namely the information on whether there is damage to the vehicle C or not, on the output unit of the user I/F unit 240. The administrator can thus recognize whether damage has occurred or not based on the image and the user's own inspection result.

With the above configuration, the administrator who uses the vehicle management system 200 can receive a notification that the vehicle C may have been damaged (first notification) and the user's own inspection result of whether there is damage to the vehicle C or not (second notification). This allows the administrator to recognize damage to the vehicle C early. Moreover, the user can share the fact that damage has occurred to the vehicle C with the administrator before the administrator inspects the vehicle C for damage. This reduces administrator's time and effort for damage inspection.

In the present embodiment, the inspection information 130b is stored in the information management system 100, and in response to a request from an external device, the inspection information 130b is transmitted to the requesting device. That is, when the vehicle management system 200 designates the identification information of the administrator's desired vehicle C at his/her desired timing to request the inspection information 130b, the information management system 100 transmits the designated inspection information 130b to the vehicle management system 200. The vehicle management system 200 can display the received inspection information 130b on the output unit of the user I/F unit 240. The administrator can therefore check the information on whether there is damage to the vehicle C or not and the position of damage, if any, together with an image of the position.

Since the contact information 130a is also stored in the information management system 100, an external device may be able to request transmission of the contact information 130a. For example, when the vehicle management system 200 designates the identification information of the desired vehicle C at the desired timing to request the contact information 130a, the information management system 100 may transmit the designated contact information 130a to the vehicle management system 200. In this case, the vehicle management system 200 displays the received contact information 130a on the output unit of the user I/F unit 240. The administrator can thus recognize the point where contact with an object occurred, the time contact occurred, etc. The point where contact occurred etc. may be able to be displayed by the inspection information transmission system 300 that will be described below, etc.

### (5) Configuration of Inspection Information Transmission System

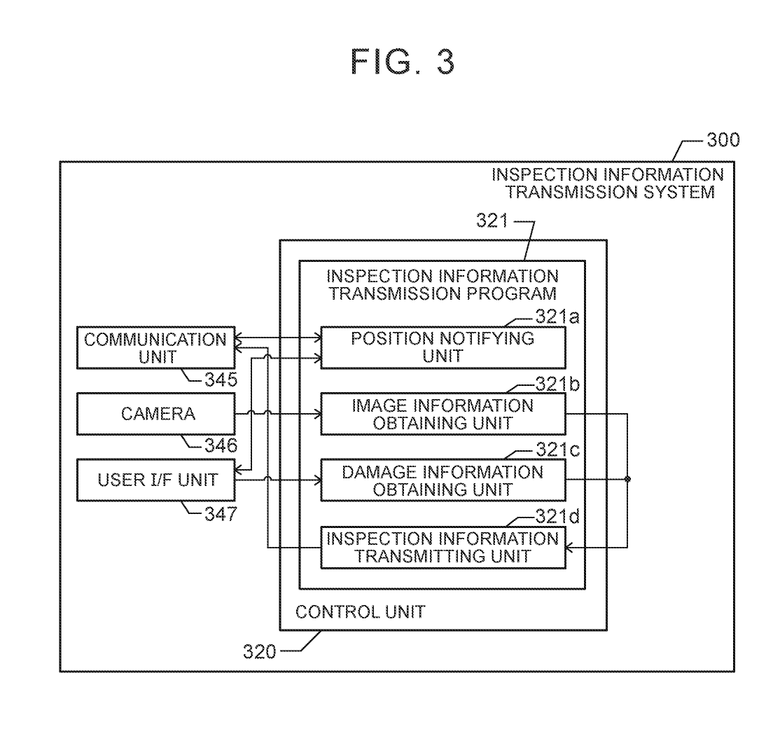

The configuration of the inspection information transmission system 300 will be described in detail. FIG. 3 is a block diagram showing the configuration of the inspection information transmission system 300. The inspection information transmission system 300 according to the present embodiment is a mobile terminal owned by the user who uses the vehicle C of the car sharing service. The user installs an application program in his/her mobile terminal before using the car sharing service. When the installed application program is executed, the mobile terminal functions as the inspection information transmission system 300. The inspection information transmission system 300 has a function that allows the user himself/herself to inspect the vehicle C for damage if the vehicle C is presumed to have been damaged by contacted with an object.

In the present embodiment, the inspection information transmission system 300 can communicate with the information management system 100. The inspection information transmission system 300 includes a control unit 320 including a CPU, a RAM, a ROM, etc., a communication unit 345, a camera 346, and a user I/F unit 347. The control unit 320 can execute an inspection information transmission program 321 stored in the recording medium 230 or the ROM.

The communication unit 345 includes a circuit that communicates with the information management system 100. By executing the inspection information transmission program 321, the control unit 320 can communicate with the information management system 100. The user I/F unit 347 includes an input unit that receives input from the administrator and an output unit that displays information. The user I/F unit 347 can display desired information on the output unit. The way in which the output unit outputs information is not limited to displaying. Voice output etc. may be used instead of displaying.

The camera 346 is a device that captures an image by generating image information indicating an image formed on an imaging element via a lens. When the camera 346 is started, the control unit 320 displays on the output unit of the user I/F unit 347 an image of an object to be captured and obtains image information captured in response to a command that is input to the input unit of the user I/F unit 347.

In the present embodiment, the inspection information transmission system 300 transmits the inspection information, namely the result of inspecting the vehicle C for damage, to the information management system 100. In order to perform the process, the inspection information transmission program 321 includes a position notifying unit 321a, an image information obtaining unit 321b, a damage information obtaining unit 321c, and an inspection information transmitting unit 321d.

The position notifying unit 321a is a program module that allows the control unit 320 to perform a function to obtain position information indicating a detected contact position of the vehicle C with an object and notify the user of the position information. That is, the control unit 320 obtains contact information 130a from the information management system 100 via the communication unit 345. The contact information 130a contains position information indicating the position of the microphone 45 that has detected contact with an object.

The control unit 320 displays the position information on the output unit of the user I/F unit 347 etc. The position information may be displayed in various manners. For example, information indicating the position of the body of the vehicle C (“contact detected on the front right side of the vehicle C” etc.) may be displayed. Displaying such position information is equivalent to notifying the user of contact between an object and the vehicle C. Based on this display, the user of the vehicle C can thus recognize the position of possible damage caused by contact with an object.

The position information also serves as capturing guidance information indicating a command to capture an image of damage of the vehicle C. That is, the control unit 320 displays on the output unit of the user I/F unit 347 the position information and guidance for capturing an image of the position indicated by the position information. According to the guidance, the user performs an operation regarding the camera 346 to capture an image with the position indicated by the position information being located in the field of view of the camera 346.

The image information obtaining unit 321b is a program module that allows the control unit 320 to perform a function to obtain image information indicating an image captured by the camera 346, namely an image of a detected contact position with an object. That is, the control unit 320 obtains image information captured by the user according to capturing guidance information.

The damage information obtaining unit 321c is a program module that allows the control unit 320 to perform a function to obtain damage information indicating whether there is damage to the vehicle C at a detected contact position with an object. That is, the control unit 320 displays on the output unit of the user I/F unit 347 selection guidance information that makes the user select whether damage has occurred to the vehicle C or not. The selection guidance information can be any information that allows the user to select whether there is damage to the vehicle C at the position indicated by the position information (the position whose image was captured by the camera 346). An example of the selection guidance information is guidance that prompts the user to input whether there is damage to the vehicle C or not by using checkboxes. When the user inputs whether there is damage to the vehicle C or not, the control unit 320 obtains damage information indicating whether there is damage to the vehicle C or not.

In the present embodiment, image information is obtained regardless of whether the user has selected that there is damage to the vehicle C or the user has selected that there is no damage to the vehicle C. However, the image information may not be obtained in the case where the user has selected that there is no damage to the vehicle C. The configuration for obtaining the image information may be implemented in various forms. For example, the configuration in which a plurality of images need to be captured, the configuration in which a plurality of images need to be captured at different distances and different angles, etc. may be used.

The inspection information transmitting unit 321d is a program module that allows the control unit 320 to perform a function to transmit inspection information containing image information and damage information. That is, the control unit 320 generates inspection information by associating identification information of the vehicle C with image information obtained by the function of the image information obtaining unit 321b and damage information obtained by the function of the damage information obtaining unit 321c. The control unit 320 transmits the inspection information to the information management system 100 via the user I/F unit 347. The information management system 100 transfers the inspection information to the vehicle management system 200.

In the present embodiment, the inspection information 130b is stored in the information management system 100, and in response to a request from an external device, the inspection information 130b is transmitted to the requesting device. That is, when the inspection information transmission system 300 designates the identification information of the user's desired vehicle C at his/her desired timing to request the inspection information 130b, the information management system 100 transmits the designated inspection information 130b to the inspection information transmission system 300. The inspection information transmission system 300 can display the received inspection information 130b on the output unit of the user I/F unit 347. The user can therefore check the information on whether there is damage to his/her vehicle C or not and the position of damage, if any, together with an image of the position.

### (6) Contact Information Transmission Process

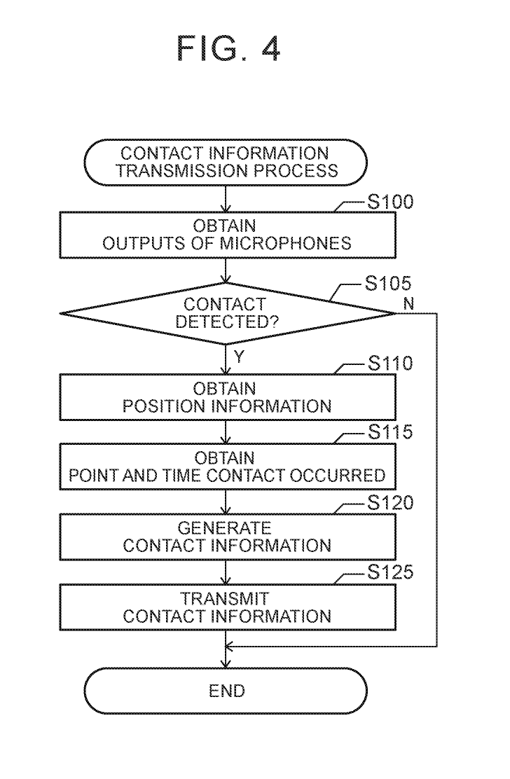

A contact information transmission process that is performed by the navigation system 10 will be described in detail. FIG. 4 is a flowchart of the contact information transmission process. When the navigation system 10 is started, the control unit 20 of the navigation system 10 performs the contact information transmission process at certain intervals (e.g., every 100 ms). When the navigation system 10 is in operation, the control unit 20 obtains at certain intervals the current position of the vehicle C based on the output signals of the GNSS receiving unit 41, the vehicle speed sensor 42, and the gyro sensor 43 and records the current position together with the current time in the RAM etc.

In the contact information transmission process, the control unit 20 obtains outputs of the microphones 45 by the function of the contact detecting unit 21a (step S100). That is, the control unit 20 continuously performs the process of sequentially recording outputs signals of the plurality of microphones 45 of the vehicle C in the memory such as the RAM and, at the timing of performing step S100, obtains the output signals output during a predetermined period before the current time together with the positions of the microphones 45.

The control unit 20 determines if contact has been detected by the function of the contact detecting unit 21a (step S105). That is, the control unit 20 analyzes the output signal of each microphone 45 by using an amplitude threshold etc. to determine if the output signal is a signal indicating contact of an object. If there is any output signal that is determined to be a signal indicating contact of an object, the control unit 20 determines that contact between an object and the vehicle C has been detected.

If it is determined in step S105 that no contact has been detected, the control unit 20 terminates the contact information transmission process. If it is determined in step S105 that contact has been detected, the control unit 20 obtains position information by the function of the contact detecting unit 21a (step S110). That is, the control unit 20 obtains as position information the position of the microphone 45 for which it is determined in step S105 that contact has been detected.

The control unit 20 then obtains the point where contact occurred and the time contact occurred (step S115). That is, the control unit 20 obtains the current position of the vehicle C based on the output signals of the GNSS receiving unit 41, the vehicle speed sensor 42, and the gyro sensor 43 and considers the obtained current position of the vehicle C as the point where contact occurred. The control unit 20 also obtains, as the time contact occurred, the current time by using a timer circuit, not shown.

The control unit 20 then generates contact information by the function of the contact detecting unit 21a (step S120). That is, the control unit 20 extracts output signals of the microphone 45 for which it is determined in step S105 that contact has been detected. At this time, the control unit 20 extracts the output signals that were output from the microphone 45 during a predetermined period before and after detection of contact, and associates identification information of the vehicle C with the extracted output signals of the microphone 45. The control unit 20 generates contact information by associating the position information obtained in step S110 and the point contact occurred and the time contact occurred which were obtained in step S115 with the extracted output signals of the microphone 45. The control unit 20 then transmits the contact information by the function of the contact information transmitting unit 21b (step S125). That is, the control unit 20 transmits the contact information to the information management system 100 via the communication unit 44.

### (7) Information Management Process

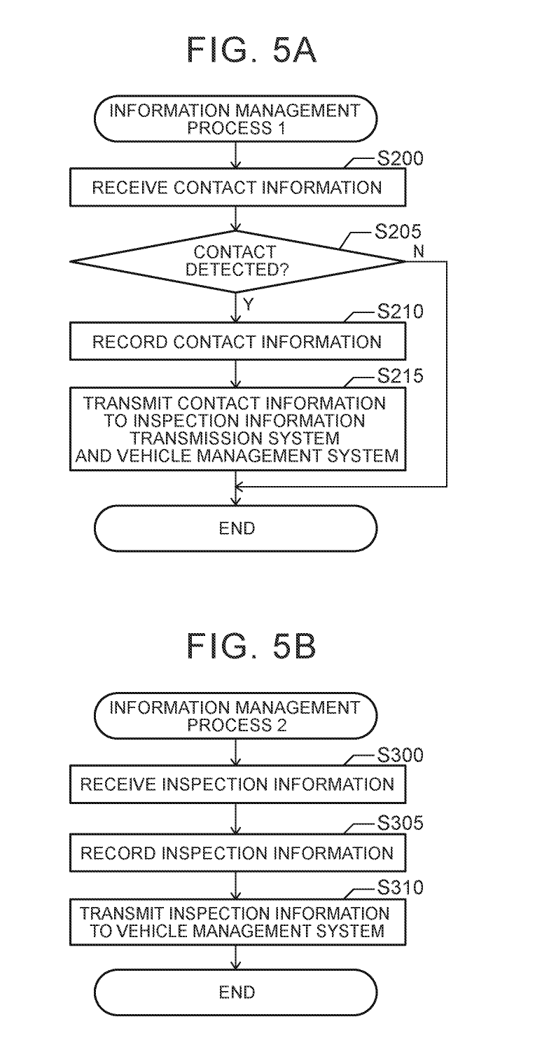

An information management process that is performed by the information management system 100 will be described in detail. FIG. 5A is a flowchart of an information management process 1 that is performed by the information management system 100 to manage contact information. The control unit 120 of the information management system 100 monitors via the communication unit 145 if the contact information has been transmitted from the navigation system 10, and performs the information management process 1 in response to transmission of the contact information.

In the information management process 1, the control unit 120 receives contact information by the function of the contact information managing unit 121a (step S200). That is, the control unit 120 receives contact information from the navigation system 10 via the communication unit 145.

The control unit 120 then determines if contact has been detected based on the received contact information by the function of the contact information managing unit 121a (step S205). The control unit 120 needs only to be able to determine if the received contact information is information is information that contact between an object and the vehicle C has been detected. Determination similar to step S105 may be made or it may be determined in detail if the contact is contact with an object. In the latter case, the control unit 120 performs a process such as determining if the received contact information is similar to the contact information 130a recorded on the recording medium 130 and associated with the information that there is damage to the vehicle C.

If it is determined in step S205 that no contact has been detected, the control unit 120 terminates the information management process 1. If it is determined in step S205 that contact has been detected, the control unit 120 records the contact information by the function of the contact information managing unit 121a (step S210). That is, the control unit 120 records the contact information received in step S200 on the recording medium 130 as contact information 130a.

The control unit 120 then transmits the contact information to the inspection information transmission system 300 and the vehicle management system 200 (step S215). That is, the control unit 120 transmits the contact information 130a recorded on the recording medium 130 in step S210 to the inspection information transmission system 300 and the vehicle management system 200 via the communication unit 145. The user who uses the inspection information transmission system 300 can thus recognize that the body of his/her vehicle C may have been damaged by contact with an object. The administrator who uses the vehicle management system 200 can also recognize that the body of the vehicle C may have been damaged.

FIG. 5B is a flowchart of an information management process 2 that is performed by the information management system 100 to manage inspection information. The control unit 120 of the information management system 100 monitors via the communication unit 145 if inspection information has been transmitted from the inspection information transmission system 300, and performs the information management process 2 in response to transmission of the inspection information.

In the information management process 2, the control unit 120 receives inspection information by the function of the inspection information managing unit 121b (step S300). That is, the control unit 120 receives inspection information from the inspection information transmission system 300 via the communication unit 145.

The control unit 120 then records the inspection information by the function of the inspection information managing unit 121b (step S305). That is, the control unit 120 records the inspection information received in S300 on the recording medium 130 as the inspection information 130b. At this time, the control unit 120 refers to the identification information of the vehicle C associated with the inspection information and specifies the contact information 130a associated with the same identification information. The control unit 120 then associates this inspection information 130b with the specified contact information 130a. The user can therefore distinguish the contact information 130a for which damage to the vehicle C was confirmed from the contact information 130a for which damage to the vehicle C was not confirmed among the contact information 130a recorded on the recording medium 130. The control unit 120 then transmits the inspection information to the vehicle management system 200 (step S310). That is, the control unit 120 transmits the inspection information 130b recorded on the recording medium 130 in step S305 to the vehicle management system 200 via the communication unit 145. The administrator who uses the vehicle management system 200 can thus recognize the user's own inspection result of whether there is damage to the vehicle C or not.

### (8) Inspection Information Transmission Process

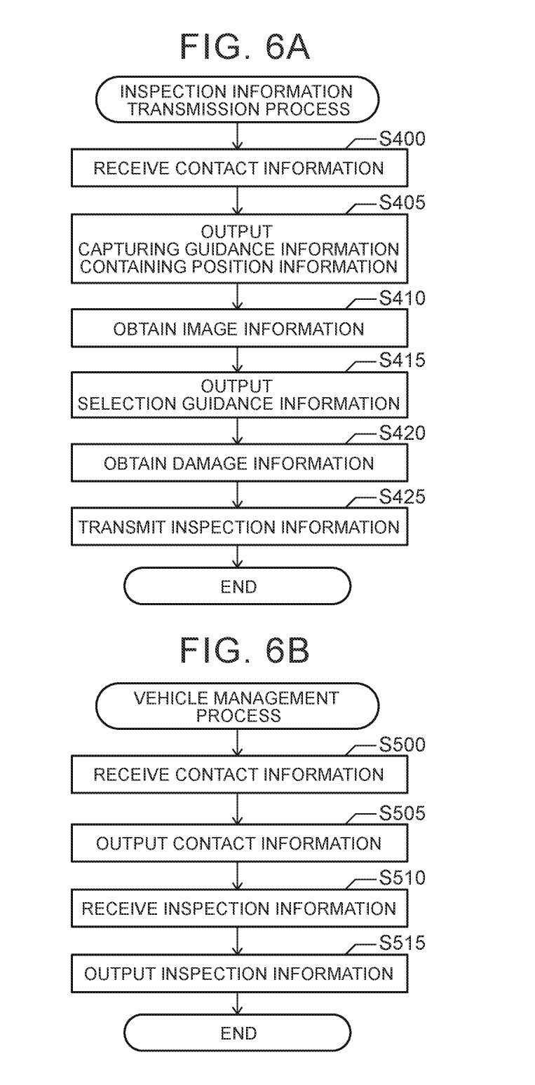

An inspection information transmission process that is performed by the inspection information transmission system 300 will be described in detail. FIG. 6A is a flowchart of the inspection information transmission process that is performed by the inspection information transmission system 300 to transmit inspection information. The control unit 320 of the inspection information transmission system 300 monitors via the communication unit 345 if contact information has been transmitted from the information management system 100, and performs the inspection information transmission process in response to transmission of the contact information.

In the inspection information transmission process, the control unit 320 receives contact information by the function of the position notifying unit 321a (step S400). That is, the control unit 320 receives contact information from the information management system 100 via the communication unit 345. The control unit 320 then outputs capturing guidance information containing position information by the function of the position notifying unit 321a (step S405). That is, since the contact information contains position information indicating the position of the microphone 45 that has detected contact of an object, the control unit 320 displays on the output unit of the user I/F unit 347 the position information together with guidance for capturing an image of the position indicated by the position information.

The user of the vehicle C recognizes from the guidance that the vehicle C may have been damaged by contact with an object. According to the guidance, the user performs an operation regarding the camera 346 to capture an image with the position indicated by the position information being located in the field of view of the camera 346.

When an image of the position is captured, the control unit 320 obtains image information by the function of the image information obtaining unit 321b (step S410). That is, the control unit 320 obtains image information output from the camera 346 by user's operation and records it on the RAM etc.

The control unit 320 then outputs by the function of the damage information obtaining unit 321c selection guidance information that makes the user select whether there is damage to the vehicle C or not (step S415). That is, the control unit 320 displays on the output unit of the user I/F unit 347 the selection guidance information that makes the user select whether there is damage to the vehicle C or not.

The control unit 320 then obtains damage information by the function of the damage information obtaining unit 321c (step S420). That is, the user inspects the body of the vehicle C for damage according to the position information. The user refers to the selection guidance information output in step S415 and inputs whether there is damage to the vehicle C or not via the input unit of the user I/F unit 347. The control unit 320 obtains damage information indicating whether there is damage to the vehicle C or not based on the user's input.

The control unit 320 then transmits inspection information by the function of the inspection information transmitting unit 321d (step S425). That is, the control unit 320 generates inspection information by associating the identification information of the vehicle C with the image information obtained in step S410 and the damage information obtained in step S420. The control unit 320 transmits the inspection information to the information management system 100 via the communication unit 345.

### (9) Vehicle Management Process

A vehicle management process that is performed by the vehicle management system 200 will be described in detail. FIG. 6B is a flowchart of the vehicle management process that is performed by the vehicle management system 200 to transmit inspection information. The control unit 220 of the vehicle management system 200 monitors via the communication unit 245 whether contact information has been transmitted from the information management system 100, and performs the vehicle management process in response to transmission of the contact information.

In the vehicle management process, the control unit 220 receives contact information by the function of the contact information obtaining unit 221a (step S500). That is, the control unit 220 receives contact information from the information management system 100 via the communication unit 245 and records the contact information on the recording medium 230.

The control unit 220 then outputs inspection information by the function of the contact information obtaining unit 221a (step S505). That is, the control unit 220 displays information regarding the contact information 230a on the output unit of the user I/F unit 240 by the function of the contact information obtaining unit 221a. The displayed information contains the identification information of the vehicle C and the position of the body of the vehicle C that is presumed to have been damaged due to contact with an object. The administrator of the vehicle C can therefore recognize the vehicle C that is presumed to have been damaged and an estimated position of damage.

The control unit 220 then receives inspection information by the function of the inspection information obtaining unit 221b (step S510). That is, the control unit 220 receives inspection information from the information management system 100 via the communication unit 245 and records the inspection information on the recording medium 230. The control unit 220 outputs the inspection information by the function of the inspection information obtaining unit 221b (step S515).

That is, the control unit 220 displays information regarding the inspection information 230b on the output unit of the user I/F unit 240 by the function of the inspection information obtaining unit 221b. The displayed information contains an image of the position where contact with an object has been detected and information set by the user, namely information indicating whether there is damage to the vehicle C or not. The administrator of the vehicle C can therefore recognize whether damage has occurred or not based on the image and the user's own inspection result.

With the above configuration, the administrator who uses the vehicle management system 200 can receive a notification that the vehicle C may have been damaged and the user's own inspection result of whether there is damage to the vehicle C or not. The administrator can thus recognize damage early. Moreover, the user can share the fact that damage has occurred to the vehicle C with the administrator before the administrator inspects the vehicle C for damage. This reduces administrator's time and effort for damage inspection.

### (10) Other Embodiments

Various other embodiments are possible as long as a first notification is sent when contact between an object and a vehicle is detected and a second notification is sent based on the result of inspecting the vehicle for damage by the user who received the first notification. For example, each system in the above embodiment may be formed by a smaller number of devices sharing the functions.

For example, at least one of the systems shown in FIG. 1A may be formed by the same device as one or more other systems. For example, the navigation system 10 and the inspection information transmission system 300 may be formed by a single device. This device may be mounted on a vehicle or may be a portable terminal etc.

The inspection information transmission system 300 and the information management system 100 may be integrated into a single system, or the information management system 100 and the vehicle management system 200 may be integrated into a single system. The configuration in which a part of the systems shown in FIG. 1A is omitted may be used. For example, the information management system 100 may be omitted. In this case, contact information is transmitted from the navigation system 10 to the vehicle management system 200, and inspection information is transmitted from the inspection information transmission system 300 to the vehicle management system 200. The system that transmits contact information to the inspection information transmission system 300 may be either the navigation system 10 or the vehicle management system 200. The systems may be formed by various other combinations, and each system may be formed by a larger number of devices than in the example shown in FIG. 1A.

At least a part of the units that form each system shown in FIG. 1A (the contact detecting unit 21a, the contact information transmitting unit 21b, the contact information managing unit 121a, the inspection information managing unit 121b, the contact information obtaining unit 221a, the inspection information obtaining unit 221b, the position notifying unit 321a, the image information obtaining unit 321b, the damage information obtaining unit 321c, and the inspection information transmitting unit 321d) may be separately present in a plurality of devices. For example, the function of the image information obtaining unit 321b may be performed by the camera 346.

The contact information obtaining unit needs only to be able to obtain contact information indicating contact between an object and a vehicle detected by the sensor for detecting contact between an object and a vehicle. In the case where contact between an object and a vehicle is detected by the sensor, the object may have damaged the body of the vehicle. Accordingly, any configuration may be used as long as contact information is obtained by the vehicle management system if damage may have occurred to the vehicle.

Contact between an object and a vehicle may be any contact that can damage the vehicle, such as contact between an object and the body of the vehicle. The sensor may be any sensor that can detect contact between an object and a vehicle, and may specify contact by various physical phenomena. For example, the sensor may detect contact by specifying the sound produced by contact or vibration, acceleration, etc. of the vehicle which are caused by contact. The sensor may detect any other physical phenomena such as a pressure that is applied to the vehicle body. Various configurations may be used for the sensor. When detecting contact, the sensor may not only detect contact of an object and but also extract contact that may damage the vehicle from the detected contacts.

Although the sensor needs only to be able to detect contact of an object, the sensor may be able to detect contact of an object in detail. That is, a plurality of sensors may be mounted on the vehicle, and the contact position with an object, that is, the positon where damage is presumed to have occurred, may be specified based on the detection results of the plurality of sensors and contained in contact information.

The inspection information obtaining unit needs only to be able to obtain inspection information, namely the result of damage inspection by the vehicle's user who is notified of contact between an object and the vehicle. That is, the inspection information obtaining unit needs only to be able to obtain inspection information based on the user's own damage inspection. The inspection information may contain various information in addition to the inspection result of whether damage has occurred or not, and may contain an image showing whether there is damage or not, etc.

The capturing guidance information indicating a command to capture an image of damage of the vehicle may be instructions on how to capture an image, or as in the above embodiment, may contain a command to capture an image of the detected contact position with an object. The detected contact position with an object may be contained in the capturing guidance information, namely the information to be output for the user of the inspection information transmission system, or may be output for the vehicle's user by other system such as the navigation system. The capturing guidance information may be produced by any desired system. The capturing guidance information may be produced by the navigation system 10, the information management system 100, the vehicle management system 200, etc. and transmitted to the inspection information transmission system 300.

The damage information may be any information that indicates whether damage has occurred to the vehicle or not. In the case where contact between an object and the vehicle is detected at a plurality of positions, damage information may be defined by associating information on whether there is damage or not with each position. Various configurations can be used for production of the damage information.

The recording medium that stores contact information or inspection information therein may be included in various devices. The recording medium may be included in the vehicle management system, the inspection information transmission system, the navigation system, etc. or may be included in other systems. The recording medium may be included in a plurality of devices.

The technique of sending the first notification when contact between an object and a vehicle is detected and sending the second notification based on the result of damage inspection by the user who is notified of the detection of contact as in the present embodiment can also be used as a program or a method. The system, program, and method as described above may be implemented as an independent device or may be implemented by using parts common to each part included in a vehicle. The system, program, and method as described above can thus be implemented in various forms. The system, program, and method may be modified as appropriate such as being implemented partly by software and partly by hardware. Exemplary embodiments may also be implemented as a recording medium for a program that controls the system. This recording medium may be either a magnetic recording medium or a magneto-optical recording medium.

What is claimed is:

1. A vehicle management system, comprising:
a processor programmed to:
receive contact information indicating contact between an object and a vehicle, the contact information having been detected by a sensor that detects contact between the object and the vehicle; and
obtain inspection information, the inspection information being a result of inspecting the vehicle for damage by a user of the vehicle who is notified of the contact between the object and the vehicle from having received the contact information.

2. The vehicle management system according to claim 1, wherein
the user of the vehicle is notified of the contact between the object and the vehicle by an inspection information transmission system that is used by the user; and
when the inspection information transmission system notifies the user of the contact between the object and the vehicle, the inspection information transmission system:
outputs capturing guidance information to the user, the capturing guidance information indicating a command for the user to capture an image of the damage of the vehicle, the capturing guidance information including image information containing the image of the damage captured by the user in the inspection information; and
transmits the resultant inspection information.

3. The vehicle management system according to claim 2, wherein
the capturing guidance information contains a command to capture an image of a detected contact position with the object.

4. The vehicle management system according to claim 3, wherein
when the inspection information transmission system notifies the user of the contact between the object and the vehicle, the inspection information transmission system:
outputs to the user selection guidance information for selecting whether the damage has occurred to the vehicle;
includes damage information selected by the user in the inspection information, the damage information indicating whether there is damage to the vehicle; and
transmits the resultant inspection information to the processor.

5. The vehicle management system according to claim 4, further comprising a memory, wherein the processor is programmed to:
store the inspection information in the memory; and
transmit the inspection information to an external device in response to a request from the device.

6. The vehicle management system according to claim 1, further comprising a memory, wherein the processor is programmed to:
store the inspection information in the memory; and
transmit the inspection information to an external device in response to a request from the device.

7. The vehicle management system according to claim 2, wherein
when the inspection information transmission system notifies the user of the contact between the object and the vehicle, the inspection information transmission system:
outputs selection guidance information to the user for selecting whether the damage has occurred to the vehicle;
includes damage information selected by the user in the inspection information, the damage information being information indicating whether there is damage to the vehicle; and
transmits the resultant inspection information.

8. The vehicle management system according to claim 2, further comprising a memory, wherein the processor is programmed to:
store the inspection information in the memory; and
transmit the inspection information to an external device in response to a request from the device.

9. The vehicle management system according to claim 7, further comprising a memory, wherein the processor is programmed to:
store the inspection information in the memory; and
transmit the inspection information to an external device in response to a request from the device.

10. The vehicle management system according to claim 3, further comprising a memory, wherein the processor is programmed to:
store the inspection information in the memory; and
transmit the inspection information to an external device in response to a request from the device.

11. An inspection information transmission system, comprising:
a processor programmed to:
obtain position information indicating a detected contact position of a vehicle with an object;
notify a user of the obtained position information;
obtain image information indicating an image of the detected contact position, the obtained image information having been captured by a camera;
obtain damage information indicating whether there is damage to the vehicle at the detected contact position; and
transmit inspection information containing the obtained image information and the obtained damage information.

12. An information management system, comprising:
a processor programmed to:
obtain contact information indicating contact between an object and a vehicle, the contact information having been detected by a sensor that detects contact between the object and the vehicle;
transmit the obtained contact information to a vehicle management system that is used by an administrator of the vehicle and an inspection information transmission system that is used by a user of the vehicle; and
obtain inspection information, the inspection information being a result of inspecting the vehicle for damage by the user by using the inspection information transmission system; and
transmit the inspection information to the vehicle management system.

13. A computer-readable recording medium storing a computer-executable vehicle management program that, when executed, causes a computer to:
receive contact information indicating contact between an object and a vehicle, the contact information having been detected by a sensor that detects contact between the object and the vehicle; and
obtain inspection information, the inspection information being a result of inspecting the vehicle for damage by a user of the vehicle who is notified of the contact between the object and the vehicle from having received the contact information.

14. A computer-readable recording medium storing a computer-executable inspection information transmission program that, when executed, causes a computer to:
obtain position information indicating a detected contact position of a vehicle with an object;
notify a user of the obtained position information;
obtain image information indicating an image of the detected contact position, the obtained image information having been captured by a camera;
obtain damage information indicating whether there is damage to the vehicle at the detected contact position; and
transmit inspection information containing the obtained image information and the obtained damage information.

15. A computer-readable recording medium storing a computer-executable information management program that, when executed, causes a computer to:
obtain contact information indicating contact between an object and a vehicle, the contact information having been detected by a sensor that detects contact between the object and the vehicle;
transmit the obtained contact information to a vehicle management system that is used by an administrator of the vehicle and an inspection information transmission system that is used by a user of the vehicle; and
obtain inspection information, the inspection information being a result of inspecting the vehicle for damage by the user by using the inspection information transmission system; and
transmit the inspection information to the vehicle management system.
